(19) United States
(12) Patent Application Publication
(10) Pub. No.: US 2026/0001290 A1
(43) Pub. Date: Jan. 1, 2026

(54) LASER TO PLATE PULSE EFFECT

(71) Applicant: Idemia Identity & Security USA, LLC, Reston, VA (US)

(72) Inventors: Garret OZBOLT, Somerville, MA (US); Juliet SOOHOO, Needham, MA (US); Melissa MORAN-BAEZ, Randolph, MA (US); Katherine TERNULLO, Bedford, MA (US)

(73) Assignee: Idemia Identity & Security USA, LLC, Reston, VA (US)

(21) Appl. No.: 18/756,884

(22) Filed: Jun. 27, 2024

(51) Int. Cl. B29D 11/00; B29C 59/00; B29K 27/06; B29K 69/00; B29K 105/20

(52) U.S. Cl. CPC B29D 11/00317; B29C 59/005; B29K 2027/06; B29K 2069/00; B29K 2105/20

(57) ABSTRACT

A substrate for security verification, including a transparent, laser-markable outer layer on at least one surface, the at least one surface including an image formed by a plurality of contours, each contour of the plurality of contours having at least one curved segment; and a plurality of raised lenses arranged in rows on the at least one surface of the substrate, wherein each row of the rows of raised lenses is aligned with a contour of the plurality of contours, and a focal point of a raised lens in a row of raised lenses is aligned with a first contour of the plurality of contours at a first viewing angle and aligned with a second contour of the plurality of contours at a second viewing angle.

### BACKGROUND

### Field of the Disclosure

The present disclosure relates to the design and structure of substrates having security features.

### Description of the Related Art

The addition of security features to documents can prevent forgeries of said documents. Effective security features can be easily recognizable yet difficult to fabricate. Such security features can be applied to documents such as passports or identification cards.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is directed to a substrate for security verification, comprising a transparent, laser-markable outer layer on at least one surface, the at least one surface including an image formed by a plurality of contours, each contour of the plurality of contours having at least one curved segment, and a plurality of raised lenses arranged in rows on the at least one surface of the substrate, wherein each row of the rows of raised lenses is aligned with a contour of the plurality of contours, and a focal point of a raised lens in a row of raised lenses is aligned with a first contour of the plurality of contours at a first viewing angle and aligned with a second contour of the plurality of contours at a second viewing angle.

In one embodiment, the present disclosure is directed to a substrate for security verification, comprising a transparent, laser-markable outer layer on at least one surface, the at least one surface including an image formed by a plurality of contours, each contour of the plurality of contours having at least one curved segment, and a plurality of raised lenses arranged in rows on the at least one surface of the substrate, wherein each row of the rows of raised lenses is aligned with a contour of the plurality of contours.

In one embodiment, the present disclosure is directed to a method of fabricating a substrate for security verification, comprising: embossing rows of raised lenses on at least one surface of the substrate, the at least one surface including a transparent, laser-markable outer layer; and engraving a plurality of contours of an image on the at least one surface of the substrate, each contour of the plurality of contours having at least one curved segment, wherein each row of the rows of raised lenses is aligned with a contour of the plurality of contours, and a focal point of a raised lens in a row of raised lenses is aligned with a first contour of the plurality of contours at a first viewing angle and aligned with a second contour of the plurality of contours at a second viewing angle.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is an illustration of an engraved feature according to one embodiment of the present disclosure;

FIG. 1B is an illustration of a machined part of the feature according to one embodiment of the present disclosure;

FIG. 1C is an illustration of a security feature according to one embodiment of the present disclosure;

FIG. 2A is a cross-section of a substrate according to one embodiment of the present disclosure;

FIG. 2B is a cross-section of a substrate according to one embodiment of the present disclosure;

FIG. 2C is a cross-section of a substrate according to one embodiment of the present disclosure;

FIG. 3A is an illustration of a machined part of a security feature according to one embodiment of the present disclosure;

FIG. 3B is an illustration of a laser marking layer of a security feature according to one embodiment of the present disclosure;

FIG. 3C is an illustration of a light path in a security feature according to one embodiment of the present disclosure;

FIG. 3D is an illustration of a visual effect of a security feature according to one embodiment of the present disclosure; and

FIG. 4 is a method of fabricating a substrate according to one embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to a substrate having a physical security feature. In one embodiment, the substrate can be a security document, such as a page in a passport or a document used for conveying confidential or verified information. In one embodiment, the substrate can be a card, such as a payment card, identification card, access card, etc. Physical features of the substrate can convey information via visual or tactile interactions with the substrate. For example, the substrate can include printed information or an image that is engraved onto the substrate. In one embodiment, a physical security feature (or “security feature”) can be used to verify the origin, ownership, or legitimacy of the card. In one embodiment, a security feature can include personalized information, e.g., information about a document manufacturer, issuer, owner, user, etc.

An effective security feature can be created using a tooling process that is difficult to characterize or mimic. In one embodiment, a security feature of a substrate can include a combination of engraved and machined features. The combination of engraved and machined features can create a visual effect that can be easily verified without specialized optical instruments. In one embodiment, an engraved feature can be an image. In one embodiment, the design and characteristics of the machined features can be based on the image. The combination of the machined features and the engraved features can thereby create a visual effect on the substrate that is easy to verify and difficult to recreate.

In one embodiment, each contour of the plurality of contours has a uniform brightness. Specifically, the first contour of the plurality of contours has a first brightness and the second contour of the plurality of contours has a second brightness.

In one embodiment, the machined security features can include transparent lenses or microlenses formed on a surface of the substrate. In one embodiment, the lenses can be embossed or cast onto the surface of the substrate. The transparent lenses can be, raised elements or projections having a convex surface. Each lens can have characteristics including, but not limited to, a pitch, thickness (depth or height), and refractive index. In one embodiment, the lenses can be approximately pill-shaped (stadium-shaped), and the lens characteristics can include a length, width, and radius. In one embodiment, lenses can be approximately circular or oval in shape. In one example, a lens can be approximately 16±5 μm (micrometers, microns) in height with a width of approximately 25 μm. In one example, the pitch of a lens can be approximately 40 μm. The characteristics of a lens can vary depending on a lens pattern or intended visual effect. For example, a visual effect can include a combination of lenses of different lengths, orientations, etc.

In one embodiment, the lenses can be arranged in a lens pattern on the substrate and can overlap with an image on the surface of the substrate. In one embodiment, the image can be engraved on the surface of the substrate or beneath the surface of the substrate via a laser etching. The lenses can direct (focus) light towards the image to create a dynamic visual effect. For example, the lenses can cause the appearance of the image to change based on a viewing angle of the substrate. The viewing angle of the substrate can refer to an orientation or angle of the substrate relative to a viewer. In one embodiment, the lenses can be lenticular lenses, and different regions of the image can be visible at different viewing angles. In one embodiment, the image can have a different appearance at different viewing angles. For example, a region of the image can be illuminated at a first viewing angle and not illuminated at a second viewing angle. Notably, the image and the machined features do not physically change when the viewing angle changes. Rather, the lenses overlaid on the image create a varying visual effect that can be used to identify or validate the substrate.

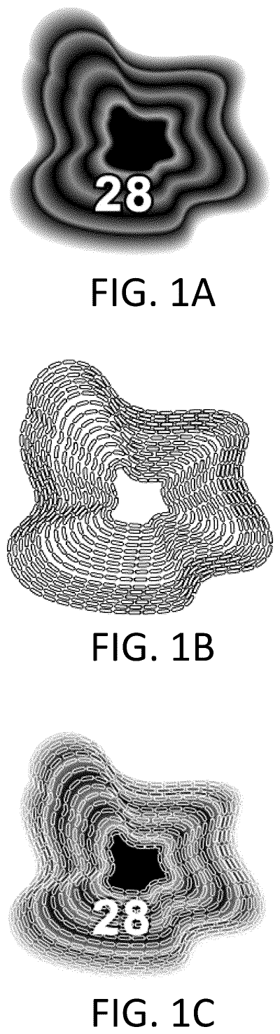

FIG. 1A is an illustration of an engraved image of a security feature according to one embodiment. The image can be a curved shape with at least one curved segment. In one embodiment, the image can be an organic shape. In one embodiment, the image can be an enclosed shape. In one embodiment, the image can include one or more colors or shades having different brightness, e.g., black, white, and gray, as illustrated in FIG. 1A. In one embodiment, the image can be comprised of contours of different colors or shades. In one embodiment, adjacent contours can have different brightnesses, as illustrated in FIG. 1A. Each contour can be a closed segment or a partial contour (e.g., a discontinuous line segment). Each contour can include at least one curved segment. In one embodiment, the contours can be concentric. In one embodiment, the contours can create a brightness gradient of dark-to-light (and/or light-to-dark) shades of a color. For example, adjacent contours can gradually increase or decrease in brightness according to a certain step size.

In one embodiment, the gradient can be repeated across the image. For example, the image of FIG. 1A includes a plurality of contours radially repeating from the outer edge of the organic shape to the center of the organic shape. In one embodiment, the lenses can create an appearance of a luminance gradient across the image (e.g., light moving across the image) when the viewing angle changes. In one embodiment, the luminance gradient can be a single-color gradient due to the size of the lenses not resulting in diffraction grating. The intensity of colors of the image can vary when viewed through the lenses at different angles. The brightness of the same contour is not necessarily uniform in the luminance gradient due to different lens direction depending on the shape and lens spacing for example.

In one embodiment, the image can include text (letters, numbers, characters, symbols, etc.). In one embodiment, the text can be arranged in a pattern or shape. The pattern or shape can include at least one curved segment. In one embodiment, the text can be arranged to form an organic shape, overlaid on an organic shape, overlapping with an organic shape, or separate from an organic shape. In one embodiment, the text can include identifying data or personalized information.

FIG. 1B is an illustration of machined lenses forming a lens pattern of a security feature according to one embodiment. The lens pattern of FIG. 1B can correspond to the shape of the image of FIG. 1A. For example, the lenses of FIG. 1B can form the same shape as the image of FIG. 1A and can be overlaid on the image of FIG. 1A. In one embodiment, the lens pattern can include two or more concentric rows of lenses. Lenses within a row can be spaced apart by a lens spacing. Rows of lenses can be separated from each other by a row spacing. In one embodiment, the lens spacing and/or the row spacing can be set according to the image. For example, the row spacing can be set based on the width of the image contours. In one embodiment, the lens spacing and/or the row spacing can be set based on the curvature(s) of the image. In one embodiment, the spacing between lenses can be between approximately 25 to approximately 40 μm. In one embodiment, the spacing between lenses can be less than 25 or greater than 40 μm.

In one embodiment, the length of each lens can be set according to the lens pattern or the image. For example, shorter lenses can be used to form a lens pattern with steeper curves or bends. In one embodiment, the lens spacing and the row spacing can be set in order to achieve a certain visual effect. For example, lenses that are closer together can create a more dynamic visual effect, wherein the appearance of the image changes more quickly with a change in viewing angle than when the lenses are further apart.

In one embodiment, the lens spacing and/or the row spacing can vary in a single lens pattern of a security feature. In one embodiment, the lens spacing can vary within a row, the varying spacing being to achieve a desired intensity and direction of the pulse. For example, lenses in a first segment of a row can be closer together than lenses in a second segment of the same row. In one embodiment, row spacing can vary in a lens pattern. For example, rows at the outer edge of the pattern can be closer together than lens at the center of the pattern, as illustrated in FIG. 1B. Similarly, spacing between contours in the image can vary within a security feature.

FIG. 1C is an illustration of a security feature having a lens pattern formed on top of an image according to one embodiment. In one embodiment, the rows of lenses can be aligned with contours in the image. For example, each row of lenses can be overlaid on a contour in the image. The lens pattern can direct light in various directions. In one embodiment, the concentric rows of lenses can create a visual effect of light moving across the image when the viewing angle of the security feature is changed. In one example, the visual effect can include light moving radially across the image, e.g., from the center of the image to the edge of the image and vice versa. The visual effect can be a pulse or flash of light, or a pulse or flash of color according to the color of the image. In one embodiment, the visual effect can include an illumination of a region of the image. The region of illumination can move radially across the image. For example, a first illumination of a first region of the security feature can be different from a second illumination of a second region of the security feature. The illumination of each region of the security feature changes as the viewing angle of the security feature changes.

In one embodiment, the visual effect of the security feature can be used to identify or validate the substrate. In one example, the substrate can be a card, such as an identification or payment card. The security feature, including the image and the lenses, can be located in any region of the card or can cover the card. In one example, the substrate can be an identification page in a passport. The security feature, including the image and the lenses, can be located in any region of the substrate. In one embodiment, the image of the security feature can include personalized information, such as an alphanumeric sequence that is unique to the passport holder, the name of the passport holder, an image of the passport holder, etc. The appearance of the identification page (as an example of a substrate) can change when the viewing angle of the identification page is changed. For example, a region of the identification page can appear illuminated or can reflect or refract an amount of light at a first viewing angle. A different region of the identification page can appear illuminated or can reflect or refract the amount of light at a second viewing angle. A viewer, such as a security official, can change the orientation of the identification page to change the viewing angle. A continuous movement of the identification page can result in the region of illumination moving across the identification page in a continuous, fluid movement. In one embodiment, the region of illumination can move radially away from or towards the center of the image of the security feature. The movement of the region of illumination can follow the shape (e.g., an organic shape) of the image of the security feature. The presence and movement of light across the identification page can be used to verify the identification page. In one embodiment, the security feature can span across more than one page (e.g., identification pages). The region of illumination can move continuously across the more than one page as described above as the viewing angle changes.

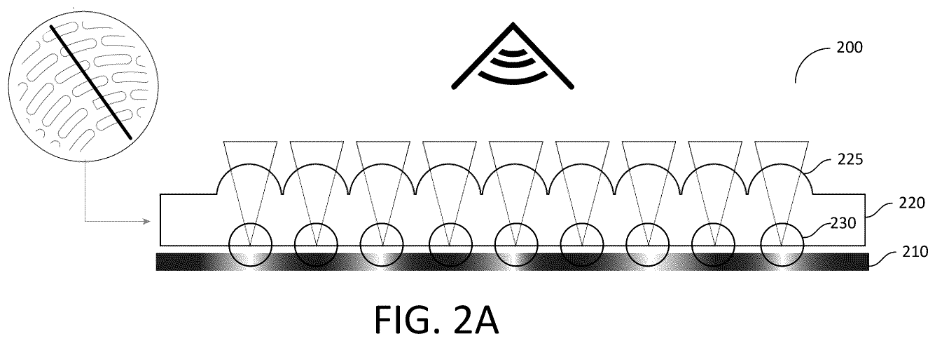

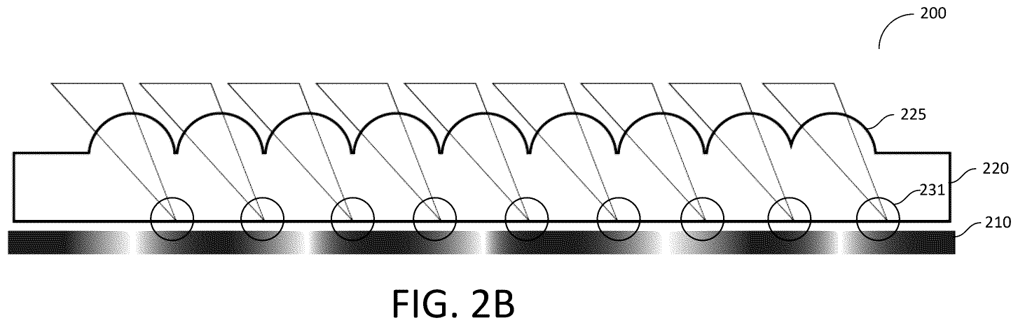

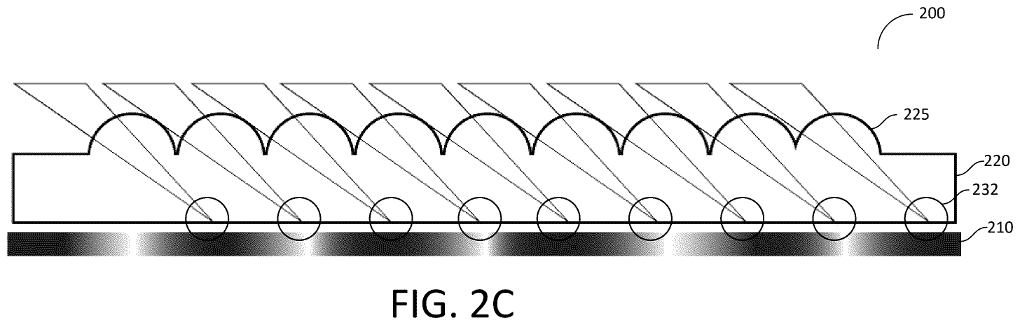

FIG. 2A is a cross-section of a substrate 200 according to one embodiment. The substrate 200 can include a body 210 having a laser blend marking. In one embodiment, the body 210 can be polycarbonate or metal. The substrate 200 can include an outer layer 220 that is embossed with fine line lenses 225. The cross-section can be taken across rows of lenses. Each row of lenses can be overlaid on a contour of the image. In one embodiment, each contour can have a particular brightness, as illustrated in FIG. 2A. Adjacent rows can be overlaid on lines having different brightnesses. In one embodiment, each lens 225 can form a focal point at which light converges after passing through the lens 225. The dimensions of a lens can be set so that the focal point of each lens can be located on the surface of the substrate. In one embodiment, the focal point of a lens 225 can correspond to a location 230 on the image underneath the lens. For example, the focal point of each lens 225 can be the center of a contour when incident light is perpendicular to the surface of the card body.

In one embodiment, the dynamic visual effect of the lenses can depend on the focal point of each lens. The focal point of a lens, as illustrated in FIGS. 2A through 2C, can depend on the angle at which light is incident to the substrate. The location of the focal point on the image can determine whether the substrate, or a portion of the substrate, appears bright (illuminated) or dark. FIG. 2B is a cross-section of the substrate 200 according to one embodiment. Incident light can be non-perpendicular to the surface of the substrate. The focal point of each lens 225 can be a different location 231 on the surface of the substrate from the focal point location 230 in FIG. 2A. In one embodiment, the different location of the focal points can correspond to a different contour of the image. Therefore, the appearance of the substrate can be different when illuminated from the angle of FIG. 2B. For example, the region of the substrate at the cross-section of FIG. 2B can appear darker than in the orientation of FIG. 2A because the focal points of the lenses are located at darker regions of the image.

FIG. 2C is a cross-section of the substrate according to one embodiment. Incident light can be non-perpendicular to the surface of the substrate at a more acute angle than the angle of FIG. 2B. The focal point of each lens 225 can be a different location 232 on the surface of the substrate from the focal point location in FIG. 2A (230) or in FIG. 2B (231). Therefore, the appearance (e.g., luminance) of the image can be different than in FIG. 2A or FIG. 2B. In one embodiment, the change in focal point location resulting from a change in incident light can depend on the characteristics of the lenses (pitch, width, etc.).

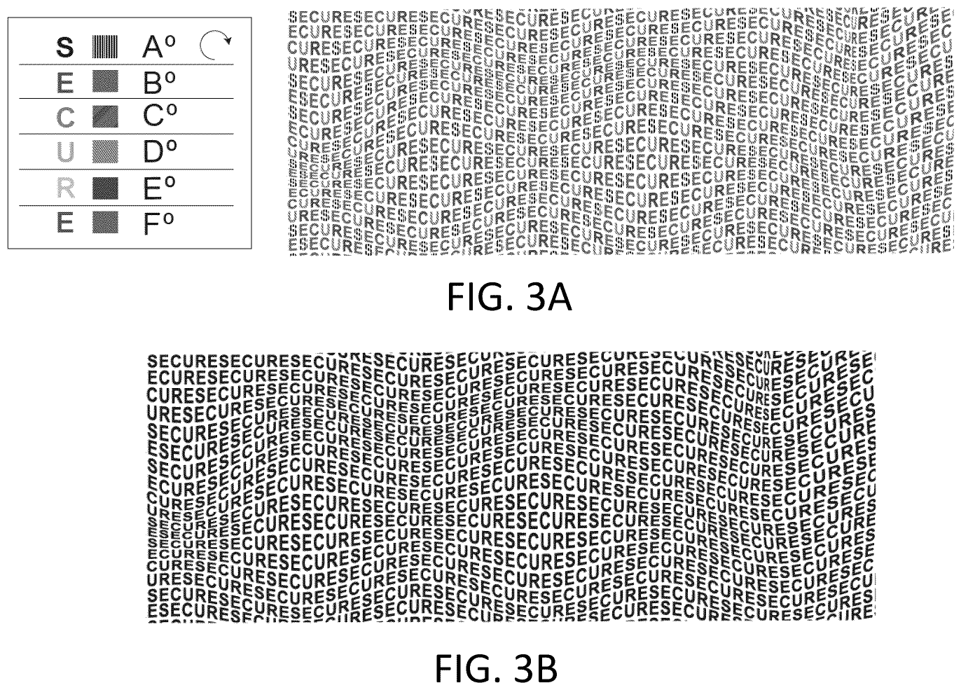

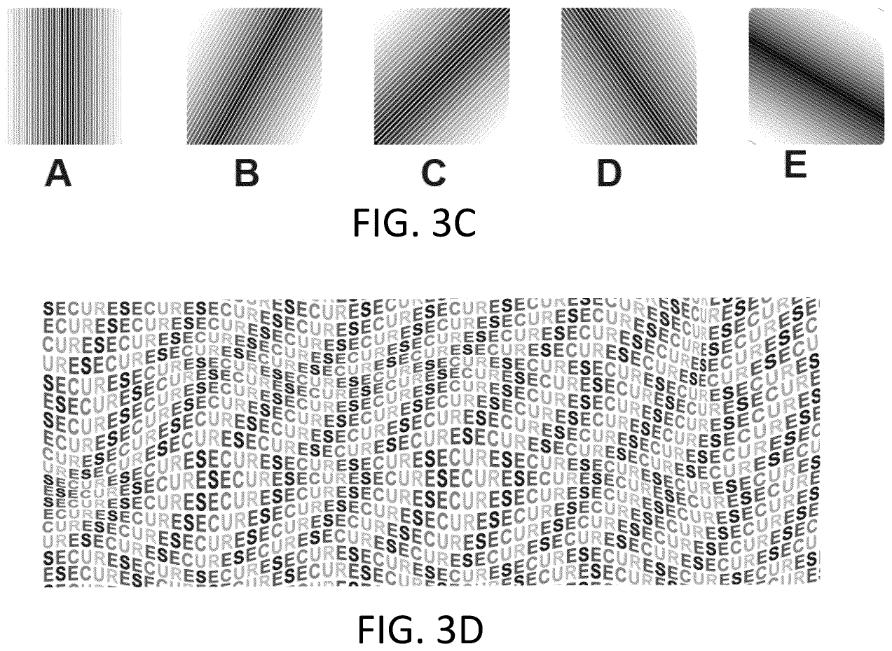

FIG. 3A is an illustration of machined lenses forming a lens pattern of a security feature according to one embodiment. The lenses can be pitched lenses that are embossed or cast onto the surface of a card substrate. (e.g., a laminate). In one embodiment, the lenses can be arranged in a rectangular area of the card, as illustrated in FIG. 3A. In one embodiment, the lens pattern can include horizontal contours across the rectangular area, wherein each horizontal contour can include at least one curved segment. In one embodiment, the lens pattern can correspond to text in an image. Each lens can be positioned over a letter in the text. In one embodiment, advantageously at least two lenses are positioned per character to establish different viewing angles per character. The lenses can direct light toward different letters at different viewing angles. For example, the legend of FIG. 3A illustrates angles corresponding to different letters in the text. As an example, angle A can be 90°, angle B can be 60°, angle C can be 45°, angle D can be 125°, angle E can be 150°, and angle F can be 60°. Each letter, which can be repeated across the security feature, can appear illuminated at a certain viewing angle due to the position and orientation of the corresponding lens.

FIG. 3B is an illustration of an engraved image of a security feature corresponding to the lenses of FIG. 3A according to one embodiment. The image can be a laser-marked image. The image can include text arranged in a rectangular area. The text can be arranged in horizontal contours, wherein each contour can include at least one curved segment. In one embodiment, the curved pattern of the text and the corresponding lenses can create a visual effect of light moving from left to right across the text as the viewing angle of the security feature changes. In one embodiment, the text itself can be engraved such that each letter has a different brightness to create the dynamic visual effect of the lenses. The brightness can refer to the color or shade of the letter itself. In one embodiment, the brightness of an image can be based on a spectrum from dark to light shades of a single color (e.g., from black to white) and can be controlled by a laser intensity during the engraving process. An example of the brightness of different letters is illustrated in the legend of FIG. 3A.

FIG. 3C is an illustration of the movement of light as the viewing angle of the security feature changes according to one embodiment. In one embodiment, the focal point of the lenses can shift in a continuous motion as the security feature is tilted or rotated. In one embodiment, a different laser marking can come into the focal point as the security feature is rotated from left to right, e.g., from angle A to angle E. The laser marking that is in the path of a particular lens' focal point can be visible and illuminated at each position (angle). As an example, angle A can be 90°, angle B can be 60°, angle C can be 45°, angle D can be 125°, angle E can be 150°, and angle F can be 60°.

FIG. 3D is an illustration of the visual effect of movement (e.g., tilting) of the security feature. As the viewing angle of the security feature changes, the focal point of the lenses changes and different letters can appear brighter or darker. As an illustrative example, the text of the engraved image can read “SECURE” repeatedly. The curved contours of the text and the corresponding lens pattern can result in repeated letters being visible and illuminated at certain viewing angles. For example, at a first viewing angle, the focal point of the lenses can be such that the letter “U” in each instance of the word SECURE is illuminated, while the letter “S” in each instance is darker. In one embodiment, each instance of a letter can have approximately the same luminance at a set viewing angle. At a second viewing angle, the region(s) of illumination can shift so that a different letter (e.g., “E”) in each instance of the word SECURE is illuminated, while the letter “U” in each instance is darker. Changing the viewing angle of the security feature by tilting the security feature from left to right can create a visual effect of movement that is dependent on the pitched lenses assigned to each synchronized letter.

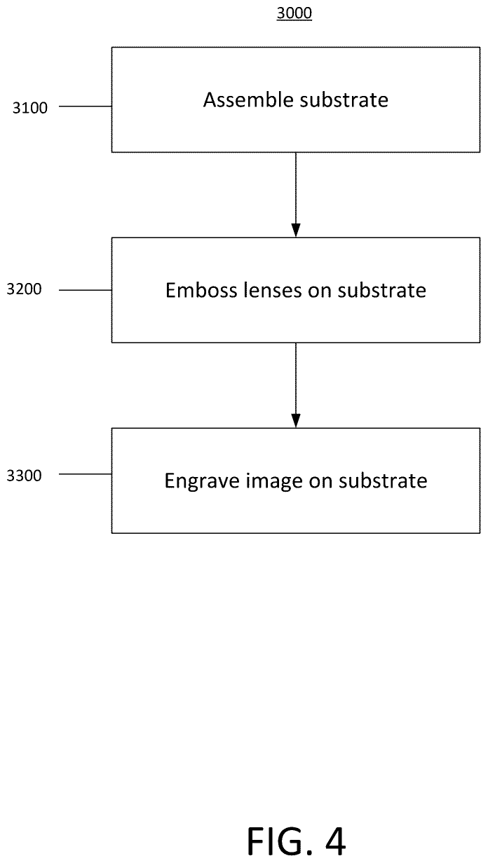

FIG. 4 is a method 3000 for fabricating a substrate having a security feature according to one embodiment. In step 3100, the substrate can be assembled. The substrate can include one or more collated layers or sheets of material. The one or more layers can include plastic layers, paper layers, resin layers, and/or metal layers. In one embodiment, the one or more layers can include any material having an outer (e.g., outermost) layer on at least one surface that is transparent and laser-markable. In one embodiment, the outer layer can be a laminate that is applied to the substrate. In one embodiment, the outer layer can have a minimum thickness of approximately 100 μm. The outer layer can be the same as the material of the substrate or different from the material of the substrate. Laser-markable materials can include, but are not limited to, polycarbonate, polyethylene terephthalate (PET) and/or similar polymers (e.g., glycol-modified (PET-G), polyethylene furan-2,5-dicarboxylate (PET-F or PEF)). The outer layer can include any clear plastic having optical clarity (a degree of transparency). In one embodiment, the outer layer can be deposited on top of a substrate of a different material. For example, the substrate can be plastic (e.g., polyvinyl chloride (PVC), polyvinyl chloride acetate (PVCA)) or metal (e.g., stainless steel). In one embodiment, the substrate can include more than one material. For example, the substrate can be a card body including a metal insert, integrated circuit (IC), antenna, etc. In one embodiment, the substrate can include printed ink.

In step 3200, the lenses can be machined in or on the substrate. In one embodiment, the lenses can be machined on the outer layer when the outer layer is deposited, e.g., in a lamination procedure. The lenses can be raised elements on the surface of the substrate arranged in a lens pattern. In one embodiment, the machining process can include embossing or casting the lenses. In one embodiment, the lenses can be embossed onto the surface of the substrate. In one embodiment, the substrate can be embossed by being drawn through or pressed by one or more dies. Pressure can be applied to the substrate while the substrate is in contact with the one or more dies. A die can include raised and recessed regions forming the lens pattern. The pressure applied to the dies and the substrate results in the embossing of the lens pattern into the substrate. The lens pattern can include contours or series of lenses following a shape. Each contour can follow approximately the same shape. The shape and dimensions of the raised regions of a die can correspond to the shape and dimensions of the lenses. In one embodiment, the substrate can be heated during the embossing process. In one embodiment, the lenses can be embossed with more than one set of dies. For example, a first set of two dies can emboss a first portion of the lenses into the substrate. A second set of two dies can emboss a second portion of the lenses into the substrate. In one embodiment the lenses can be the same material with a good optical clarity as the outer layer, e.g., polycarbonate.

In step 3300, the image can be fabricated via laser engraving or marking of the substrate. A laser can heat the laser-markable surface of the substrate to cause a controlled amount of discoloration (darkening) or removal of surface material. In one embodiment, the laser can be a neodymium-doped yttrium aluminum garnet (Nd: YAG) laser. In one embodiment, the image can be fabricated by marking or engraving the raised lenses on the surface of the substrate. In one embodiment, the laser marking can be used to create different shades in the image. For example, increased laser intensity can result in a darker region of the image. The laser can be fine-tuned for a smooth or gradual change in laser intensity. The smooth change in laser intensity can result in smooth, blended brightness gradients across the image, as illustrated in FIG. 1A. A smooth brightness gradient can create the visual effect of light moving across the image once the laser marking layer is covered by the embossed layer of lenses. In one example, on a Muhlbauer CLP60 fiber laser, with a marking speed of 2.560 mm/s a laser power range: 15-30% (e.g., of a maximum power) and a frequency range: 40-105 kHz can be used.

In one embodiment, the image can include a region that is not marked by a laser. For example, in FIG. 1A, the image can include white text. The laser can be applied to the perimeter of the text to create a contrast between the unmarked (white) text and the marked (dark) region surrounding the text. In one embodiment, the image can include personalized data that is specific to a manufacturer, issuer, owner, user, etc. of the substrate. In one embodiment, the shape of the image (e.g., the organic shape) can remain the same while the personalized data can change for each substrate. The lens pattern that is embossed in step 3200 can also remain the same. Each security feature can therefore be personalized while achieving the same visual effect and using the same manufacturing method.

In one embodiment, the lens pattern can be a shape that cannot be created using straight line segments, such as the organic shape of FIG. 1B. Therefore, the embossing of step 3200 can be performed with a specific set of embossing dies that are custom tooled to create a complex series of raised fine lines. The lens pattern can be designed based on the image that is engraved onto the substrate so that the lenses are aligned with the contours of the image. The complexity of the lens pattern can prevent or dissuade the fabrication of counterfeit substrates (documents, cards, etc.). The specificity of the dimensions of the lenses and the lens pattern can also be difficult to ascertain and mimic. A lens pattern having lenses that are large or spaced far apart may be misaligned with an underlying image, resulting in no visual effect or a different visual effect. For example, light can appear to move across the security feature in large, discrete steps rather than in a smooth or continuous motion. In a similar manner, the laser engraving of the image in step 3300 can be performed with a fine-tuned laser that is configured for small, incremental changes in intensity in order to create a smooth brightness gradient. Engraving the substrate with an untuned laser or a laser with a large step size can result in no visual effect or a different visual effect.

In one embodiment, laser engraving and laser marking can be applied to a sheet of substrates. The laser engraving of step 3200 can be repeatedly applied to create lenses on the sheet at different locations, each location corresponding to a single card or document. The laser marking of step 3300 can be repeatedly applied to create image markings at the lenses at different locations on the sheet. After the engraving and the marking, the individual cards or documents can be cut from the sheet. In one embodiment, the layers of the substrate can be sealed using a vacuum or heating process prior to steps 3200 and 3300 or after steps 3200 and 3300. In one embodiment, the substrate can be coated or new layers can be added to the substrate after the security feature has been machined.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system modules and components in the embodiments described above should not be understood as requiring such separation in all embodiments, and it should be understood that the described components and systems can generally be integrated together in a single component or packaged into multiple components.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

Embodiments of the present disclosure may also be as set forth in the following parentheticals.
(1) A substrate for security verification, comprising: a transparent, laser-markable outer layer on at least one surface, the at least one surface including an image formed by a plurality of contours, each contour of the plurality of contours having at least one curved segment; and a plurality of raised lenses arranged in rows on the at least one surface of the substrate, wherein each row of the rows of raised lenses is aligned with a contour of the plurality of contours, and a focal point of a raised lens in a row of raised lenses is aligned with a first contour of the plurality of contours at a first viewing angle and aligned with a second contour of the plurality of contours at a second viewing angle.
(2) The substrate of (1), wherein the transparent, laser-markable outer layer is a polycarbonate layer.
(3) The substrate of (1) to (2), wherein adjacent contours of the image have a different brightness.
(4) The substrate of (1) to (3), wherein the plurality of contours of the image form a brightness gradient.
(5) The substrate of (1) to (4) wherein the image includes personalized data.
(6) The substrate of (1) to (5), wherein each of the plurality of raised lenses is a convex lens having a pill shape.
(7) The substrate of (1) to (6), wherein the image includes an enclosed shape of concentric contours.
(8) A substrate for security verification, comprising a transparent, laser-markable outer layer on at least one surface, the at least one surface including an image formed by a plurality of contours, each contour of the plurality of contours having at least one curved segment; and a plurality of raised lenses arranged in rows on the at least one surface of the substrate, wherein each row of the rows of raised lenses is aligned with a contour of the plurality of contours.
(9) The substrate of (8), wherein the transparent, laser-markable outer layer is a polycarbonate layer.
(10) The substrate of (8) to (9), wherein adjacent contours of the image have a different brightness.
(11) The substrate of (8) to (10), wherein the image includes personalized data.
(12) The substrate of (8) to (11), wherein each of the plurality of raised lenses is a convex lens having a pill shape.
(13) The substrate of (8) to (12), wherein the image is an enclosed shape of concentric contours.
(14) A method of fabricating a substrate for security verification, comprising: embossing rows of raised lenses on at least one surface of the substrate, the at least one surface including a transparent, laser-markable outer layer; and engraving a plurality of contours of an image on the at least one surface of the substrate, each contour of the plurality of contours having at least one curved segment, wherein each row of the rows of raised lenses is aligned with a contour of the plurality of contours, and a focal point of a raised lens in a row of raised lenses is aligned with a first contour of the plurality of contours at a first viewing angle and aligned with a second contour of the plurality of contours at a second viewing angle.
(15) The method of (14), wherein the transparent, laser-markable outer layer is a polycarbonate layer.
(16) The method of (14) to (15), wherein adjacent contours of the image are engraved with different laser intensities.
(17) The method of (14) to (16), wherein the plurality of contours of the image form a brightness gradient.
(18) The method of (14) to (17), wherein the image includes personalized data.
(19) The method of (14) to (18), wherein each of the raised lenses is a convex lens having a pill shape.
(20) The method of (14) to (19), wherein the image includes an enclosed shape of concentric contours.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A substrate for security verification, comprising:
a transparent, laser-markable outer layer on at least one surface, the at least one surface including an image formed by a plurality of contours, each contour of the plurality of contours having at least one curved segment; and
a plurality of raised lenses arranged in rows on the at least one surface of the substrate, wherein
each row of the rows of raised lenses is aligned with a contour of the plurality of contours, and
a focal point of a raised lens in a row of raised lenses is aligned with a first contour of the plurality of contours at a first viewing angle and aligned with a second contour of the plurality of contours at a second viewing angle.

2. The substrate of claim 1, wherein the transparent, laser-markable outer layer is a polycarbonate layer.

3. The substrate of claim 1, wherein adjacent contours of the image have a different brightness.

4. The substrate of claim 1, wherein the plurality of contours of the image form a brightness gradient.

5. The substrate of claim 1, wherein the image includes personalized data.

6. The substrate of claim 1, wherein each of the plurality of raised lenses is a convex lens having a pill shape.

7. The substrate of claim 1, wherein the image includes an enclosed shape of concentric contours.

8. A substrate for security verification, comprising:
a transparent, laser-markable outer layer on at least one surface, the at least one surface including an image formed by a plurality of contours, each contour of the plurality of contours having at least one curved segment; and
a plurality of raised lenses arranged in rows on the at least one surface of the substrate, wherein
each row of the rows of raised lenses is aligned with a contour of the plurality of contours.

9. The substrate of claim 8, wherein the transparent, laser-markable outer layer is a polycarbonate layer.

10. The substrate of claim 8, wherein adjacent contours of the image have a different brightness.

11. The substrate of claim 8, wherein the image includes personalized data.

12. The substrate of claim 8, wherein each of the plurality of raised lenses is a convex lens having a pill shape.

13. The substrate of claim 8, wherein the image is an enclosed shape of concentric contours.

14. A method of fabricating a substrate for security verification, comprising:
embossing rows of raised lenses on at least one surface of the substrate, the at least one surface including a transparent, laser-markable outer layer; and
engraving a plurality of contours of an image on the at least one surface of the substrate, each contour of the plurality of contours having at least one curved segment, wherein
each row of the rows of raised lenses is aligned with a contour of the plurality of contours, and
a focal point of a raised lens in a row of raised lenses is aligned with a first contour of the plurality of contours at a first viewing angle and aligned with a second contour of the plurality of contours at a second viewing angle.

15. The method of claim 14, wherein the transparent, laser-markable outer layer is a polycarbonate layer.

16. The method of claim 14, wherein adjacent contours of the image are engraved with different laser intensities.

17. The method of claim 14, wherein the plurality of contours of the image form a brightness gradient.

18. The method of claim 14, wherein the image includes personalized data.

19. The method of claim 14, wherein each of the raised lenses is a convex lens having a pill shape.

20. The method of claim 14, wherein the image includes an enclosed shape of concentric contours.
